(19) United States
(12) Patent Application Publication
(10) Pub. No.: US 2005/0212242 A1
(43) Pub. Date: Sep. 29, 2005

(54) Structure for interconnecting one carriage cart to another

(76) Inventor: Chen Kung Cheng, Taichung Hsien (TW)

Correspondence Address: TROXELL LAW OFFICE PLLC;SUITE 1404, 5205 LEESBURG PIKE, FALLS CHURCH, VA, 22041, US

(21) Appl. No.: 10/790,044

(22) Filed: Mar. 2, 2004

(51) Int. Cl. B62B 3/02

(52) U.S. Cl. 280/79.11; 280/30

(57) ABSTRACT

A structure for interconnecting one carriage cart with another. The carriage cart includes a carriage seat, a bridge section, a first connecting section, a second connecting section and a key section. The carriage seat is a polygonal body. Several wheels are disposed under the carriage seat. The bridge section is arranged on one side of the carriage seat. The first connecting section is disposed at two ends of the bridge section. The second connecting section is disposed on the carriage seat corresponding to the first connecting section. The key section is connected with the first and second connecting sections by insertion. A user can detach the bridge sections and key sections of two carriage carts and then use the key section and bridge section of one of the carriage carts to interconnect the two carriage carts. Accordingly, a carriage cart with larger carriage area can be readily formed to meet the requirement for carriage of different work pieces.

### BACKGROUND OF THE INVENTION

The present invention is related to a carriage cart, and more particularly to a structure for interconnecting one carriage cart with another.

In production line of a factory, a conveying apparatus such as a conveying belt can be used to convey work pieces from one working station to another working station. Alternatively, the work pieces can be first loaded on a carriage cart and then a worker is pulled or pushed by labor or power cart.

Different carriage carts have different loading areas. In the case that a factory is provided with carriage carts with larger area and the amount or volume of work pieces to be conveyed is not so great, the large area carriage carts will be too large to carry such work pieces. On the contrary, in the case that the factory is provided with carriage carts with smaller area and the amount or volume of work pieces to be conveyed is great, the small area carriage carts will be insufficient to carry such work pieces. Certainly, the factory can be at the same time provided with carriage carts with different loading areas to meet different requirements for carrying different work pieces. However, this is not economic.

### SUMMARY OF THE INVENTION

It is therefore a primary object of the present invention to provide a structure for interconnecting one carriage cart with another. By means of such structure, it is only necessary to provide several monotype carriage carts for a factory. The carriage carts can be conveniently and readily combined to form a carriage cart with different loading area to meet the requirement for carriage of different work pieces.

It is a further object of the present invention to provide the above structure by which the factory is only necessary to have several monotype carriage carts so that the production is more economic.

According to the above objects, the carriage cart includes a carriage seat, a bridge section, a first connecting section, a second connecting section and a key section.

The present invention can be best understood through the following description and accompanying drawings wherein:

### BRIEF DESCRIPTION OF THE DRAWINGS

FIG. 1 is a perspective view of a preferred embodiment of the present invention; and

FIGS. 2 to 5 are plane views showing that two carriage carts are interconnected by the structure of the present invention.

### DETAILED DESCRIPTION OF THE PREFERRED EMBODIMENTS

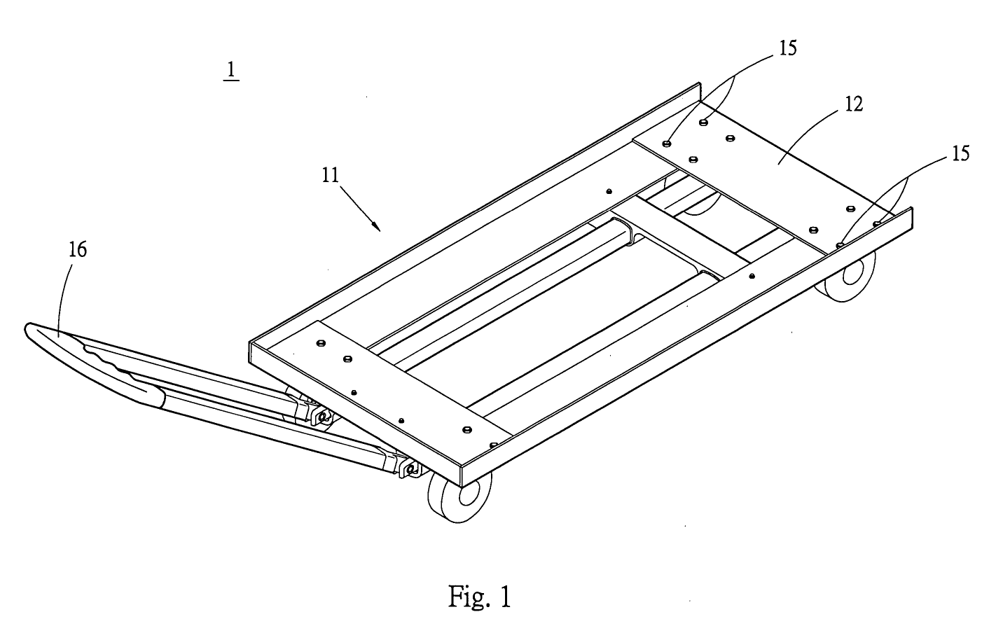

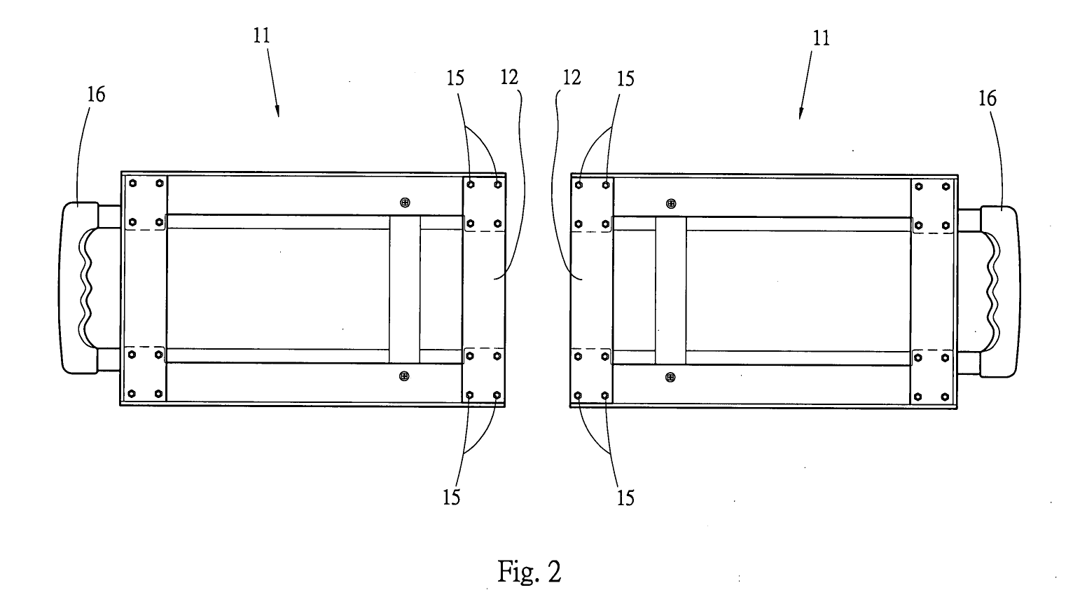

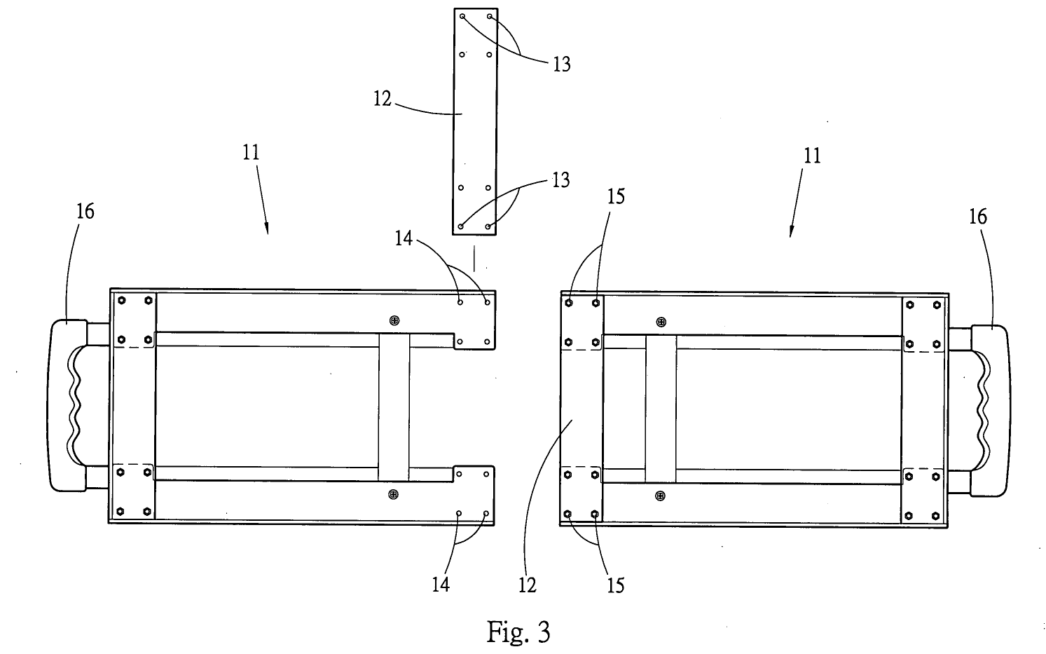

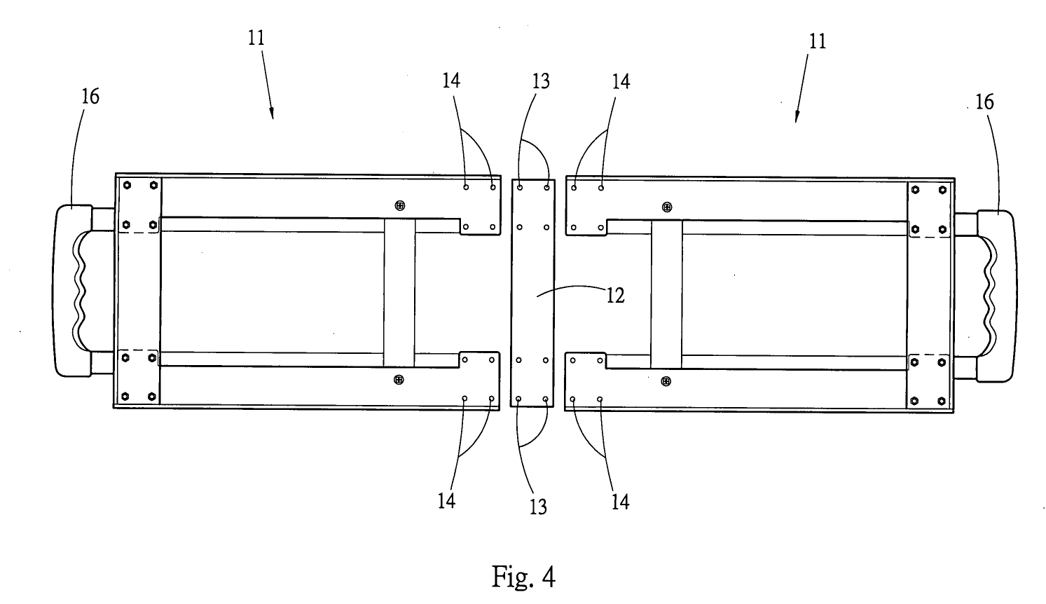

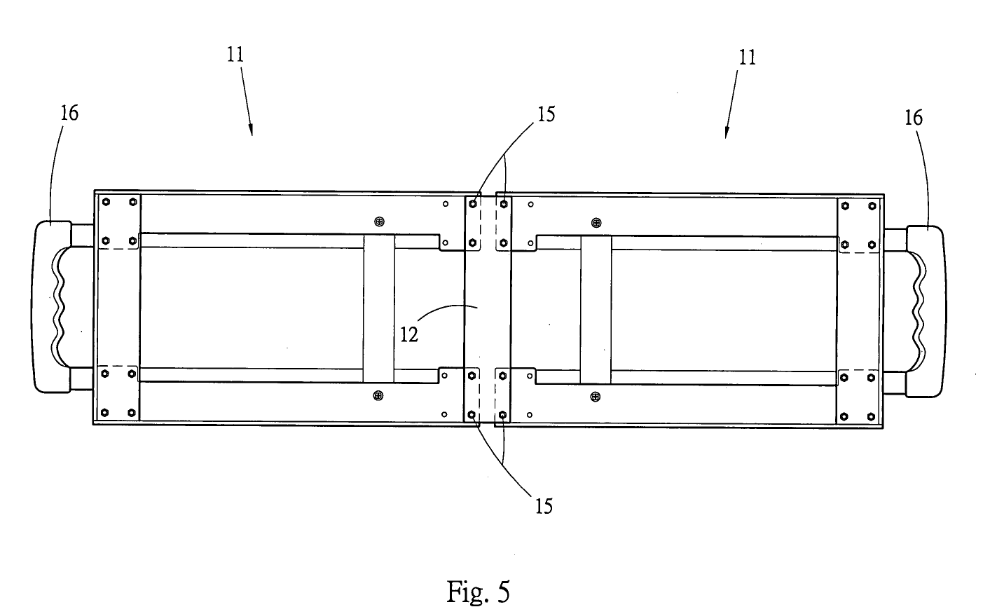

Please refer to FIGS. 1 to 5. The present invention discloses a structure for interconnecting one carriage cart with another. The carriage cart 1 includes a carriage seat 11, a bridge section 12, a first connecting section 13, a second connecting section 14 and a key sedtion 15.

The carriage seat 11 is a polygonal body such as a rectangular body formed of four slats connected with each other. Several wheels are disposed under the carriage seat 11 for rolling on the ground. The bridge section 12 is arranged on one side of the carriage seat 11.

The first connecting section 13 is disposed at two ends of the bridge section 12.

The second connecting section 14 is disposed on the carriage seat 11 corresponding to the first connecting section 12.

The key section 15 is connected with the first and second connecting sections 13, 14 by insertion.

A user can detach the bridge sections 12 and key sections 15 of two carriage carts 1 and then use the key section 15 and bridge section 12 of one of the carriage carts 1 to interconnect the two carriage carts 1. Accordingly, a carriage cart with larger loading area can be readily formed to meet the requirement for carriage of different work pieces.

According to the above arrangement, the structure for interconnecting one carriage cart with another of the present invention has the following advantages:

1. A factory is only necessary to have several monotype carriage carts. The carriage carts can be conveniently and readily combined to form a larger carriage cart with different loading area to meet the requirement for carriage of different work pieces.

2. The factory is only necessary to have several monotype carriage carts so that the production is more economic.

In the above structure, the first connecting section 13 includes at least two perforations and the second connecting section 14 includes at least one perforation. The key section 15 is a thread rod for screwing into the first and second connecting sections 13, 14 to interconnect the same.

The carriage seat 11 is equipped with a telescopic handle 16 for conveniently dragging the carriage cart 1.

The above embodiments are only used to illustrate the present invention, not intended to limit the scope thereof. Many modifications of the above embodiments can be made without departing from the spirit of the present invention.

1. (canceled)

2. The structure for interconnecting one carriage cart with another as claimed in claim 5, wherein the carriage seat is a rectangular body formed of four slats connected with each other.

3. The structure for interconnecting one carriage cart with another as claimed in claim 5, wherein the first connecting section includes at least two perforations and the second connecting section includes at least one perforation, the key section being a threaded rod for screwing into the first and second connecting sections to interconnect the same.

4. The structure for interconnecting one carriage cart with another as claimed in claim 2, wherein the first connecting section includes at least two perforations and the second connecting section includes at least one perforation, the key section being a thread rod for screwing into the first and second connecting sections to interconnect the same.

5. A structure for interconnecting first and second carriage carts, each of the first and second carriage carts comprising:
a) a bridge section connected to an end of the carriage seat and having a first connecting section located on two opposing ends thereof;
b) a carriage seat being a polygonal body having a plurality of wheels connected to a bottom thereof and a second connecting section located on opposing ends of an end thereof; and
c) a key section selectively connecting the first connecting section to the second connecting section,
wherein the key section one of the first and the second carriage carts selectively connecting the second connecting section of the first carriage cart and the second connecting section of the second carriage cart to opposing ends of the bridge section of one of the first and the second carriage carts.
